(19) United States
(12) Patent Application Publication
(10) Pub. No.: US 2018/0081037 A1
(43) Pub. Date: Mar. 22, 2018

(54) Methods Circuits Assemblies Devices Systems and Functionally Associated Machine Executable Code for Controllably Steering an Optical Beam

(71) Applicant: INNOVIZ TECHNOLOGIES LTD., Kfar Saba (IL)

(72) Inventors: Moshe Medina, Haifa (IL); Smadar David, Qiryat Ono (IL); Julian Vlaiko, Kfar Saba (IL)

(21) Appl. No.: 15/393,285

(22) Filed: Dec. 29, 2016

Related U.S. Application Data
(60) Provisional application No. 62/396,858, filed on Sep. 20, 2016.
(60) Provisional application No. 62/396,864, filed on Sep. 20, 2016.

(51) Int. Cl. G01S 7/481; G01S 7/497; G01S 17/08

(52) U.S. Cl. CPC G01S 7/4817; G01S 17/08; G01S 7/497

(57) ABSTRACT

Disclosed is a light steering device including: a mirror connected to one or more electromechanical actuators through a flexible interconnect element, one or more electromechanical actuators mechanically interconnected to a frame, and a controllable electric source to, during operation of the device, provide a sensing signal at a source voltage to an electric source contact on at least one of the one or more actuators.

### RELATED APPLICATIONS

The present application claims priority from U.S. Provisional Patent Application No. 62/396,858 entitled: “Reliability method for detecting faulty piezo MEMS mirror in a LiDAR system”, filed on Sep. 20, 2016; and from U.S. Provisional Patent Application No. 62/396,864 entitled: “Method for measuring angular deflection on MEMS PZT mirror cantilevers”, filed on Sep. 20, 2016; both of which applications are hereby incorporated by reference into the present application in their entirety.

### FIELD OF THE INVENTION

The present invention relates generally to the field of scanning devices. More specifically, the present invention relates to controllable reflective elements having a controllable steering element.

### BACKGROUND

Lidar which may also be called LADAR is a surveying method that measures distance to a target by illuminating that target with a laser light. Lidar is sometimes considered an acronym of “Light Detection And Ranging”, or a portmanteau of light and radar, and is used with terrestrial, airborne, and mobile applications.

Autonomous Vehicle Systems—are directed to vehicle level autonomous systems involving a LiDAR system. An autonomous vehicle system stands for any vehicle integrating partial or full autonomous capabilities.

Autonomous or semi-autonomous vehicles are vehicles (such as motorcycles, cars, buses, trucks and more) that at least partially control a vehicle without human input. The autonomous vehicles, sense their environment and navigate to a destination input by a user/driver.

Unmanned aerial vehicles, which may be referred to as drones are aircrafts without a human on board and may also utilize Lidar systems. Optionally, the drones may be manned/controlled autonomously or by a remote human operator.

Autonomous vehicles and drones may use Lidar technology in their systems to aid in detecting and scanning a scene/the area in which the vehicle and/or drones are operating in.

LiDAR systems, drones and autonomous (or semi-autonomous) vehicles are currently expensive and non-reliable, unsuitable for a mass market where reliability and dependence are a concern—such as the automotive market.

Host Systems are directed to generic host-level and system-level configurations and operations involving a LiDAR system. A host system stands for any computing environment that interfaces with the LiDAR, be it a vehicle system or testing/qualification environment. Such computing environment includes any device, PC, server, cloud or a combination of one or more of these. This category also covers, as a further example, interfaces to external devices such as camera and car ego-motion data (acceleration, steering wheel deflection, reverse drive, etc.). It also covers the multitude of interfaces that a LiDAR may interface with the Host system, such as CAN bus for example.

### SUMMARY OF THE INVENTION

The present invention includes methods, circuits, assemblies, devices, systems and functionally associated machine executable code for controllably steering an optical beam. According to some embodiments, a light steering device including: a mirror connected to one or more electromechanical actuators through a flexible interconnect element, one or more electromechanical actuators mechanically interconnected to a frame, and a controllable electric source to, during operation of the device, provide sensing signal at a source voltage to an electric source contact on at least one of the one or more actuators.

According to some embodiments, the light steering device may include an electrical sensing circuit connected to an electric sensing contact on at least one of the one or more actuators, and during operation of the device measure parameters of the sensing circuit. The electric source and the electrical sensing circuit may be connected to the same actuator and facilitate sensing of a mechanical deflection of the actuator to which the electric source and the electrical sensing circuit are connected. The device may include a sensor to relay a signal indicating an actual deflection determined based on the mechanical deflection. The device may include a controller to control the controllable electric source and the electrical sensing circuit. The controller may also control deflection of the actuator and may correct a steering signal based on the sensed mechanical deflection.

According to some embodiments, the electric source and the electrical sensing circuit may be each connected to a contact on two separate actuators and they may facilitate sensing of a mechanical failure of one or more elements supported by the two separate actuators. Optionally, sensing of a mechanical failure is determined based on an amplitude of a sensed current and/or or sensing of a mechanical failure is determined based on a difference between an expected current and a sensed current. Alternative embodiments substituting current with: (a) voltage, or (b) a current frequency, or (c) a voltage frequency or (d) electrical charge and more are understood.

According to some embodiments, a scanning device may include: a photonic emitter assembly (PTX) to produce pulses of inspection photons which pulses are characterized by at least one pulse parameter, a photonic reception and detection assembly (PRX) to receive reflected photons reflected back from an object, the PRX including a detector to detect the reflected photons and produce a detected scene signal, a photonic steering assembly (PSY) functionally associated with both the PTX and the PRX to direct the pulses of inspection photons in a direction of an inspected scene segment based on at least one PSY parameter and to produce a sensing signal, and a closed loop controller to: (a) control the PSY, (b) receive the sensing signal and (c) update the at least one PSY parameter at least partially based on the detected scene signal.

According to some embodiments, the sensing signal may be indicative of an actual deflection of the PSY and/or a mechanical failure.

According to some embodiments, a method of scanning utilizing a mirror assembly including a mirror and a conductive actuator may include: setting a mirror having a conductive actuator to a predetermined deflection, detecting a current through the actuator indicative of a mechanical deflection of the mirror, and determining if the predetermined direction is substantially similar to the actual deflection. The method may further include correcting the actual deflection if the predetermined deflection and the actual deflection are substantially different. The method may also include detecting an actual current through the actuator and the mirror indicative of an electro-mechanical state of the mirror assembly and comparing the actual current to an expected current and determining if a mechanical failure has occurred.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof; may best be understood by reference to the following detailed description when read with the accompanying drawings in which:

FIG. 1 shows a steering device which may be associated with or part of a scanning device in accordance with some embodiments;

FIG. 2 shows an example embodiment of a steering device and a central processing unit (CPU) in accordance with some embodiments;

FIG. 3 shows an example actuator-mirror depiction in accordance with some embodiments;

FIGS. 4A-4C show a dual axis mems mirror, a single axis mems mirror and a round mems mirror (respectively) in accordance with some embodiments;

FIGS. 5A-5C show example scanning device schematics;

FIG. 6 shows an example scanning system in accordance with some embodiments; and

FIG. 7 shows a flow chart of a method for scanning in accordance with some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities thin the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention may include methods, circuits, devices, assemblies, systems and functionally associated machine executable code for active scene scanning including devices for controllably steering an optical beam.

According to some embodiments, a scanning device may analyze a changing scene to determine/detect scene elements. When used in conjunction with a host such as a vehicle platform and/or a drone platform, the scanning device may provide a detected scene output. The host device may utilize a detected scene output or signal from the scanning device to automatically steer or operate or control the host device. Furthermore, the scanning device may receive information from the host device and update the scanning parameters accordingly. Scanning parameters may include: pulse parameters, detector parameters, steering parameters and/or otherwise. For example, a scanning device may detect an obstruction ahead and may cause the host to steer away from the obstruction. In another example the scanning device may also utilize a turning of a steering wheel and update the scanning device to analyze the area in front of the upcoming turn or if a host device is a drone a signal indicating that the drone is intended to land may cause the scanning device to analyze the scene for landing requirements instead of flight requirements.

For clarity, a light source throughout this application has been termed a “laser” however, it is understood that alternative light sources that do not fall under technical lasers may replace a laser wherever one is discussed, for example a light emitting diode (LED) based light source or otherwise. Accordingly, a Lidar may actually include a light source which is not necessarily a laser.

For clarity, a sensing signal or an electrical sensing signal may be: (a) current, (b) voltage, or (c) a current frequency, or (d) a voltage frequency or (e) electrical charge or any other electrical characteristic (such as capacitance, resistivity and more) is applicable and understood. Accordingly, any embodiments detailing a current may include any of the other options detailed herein.

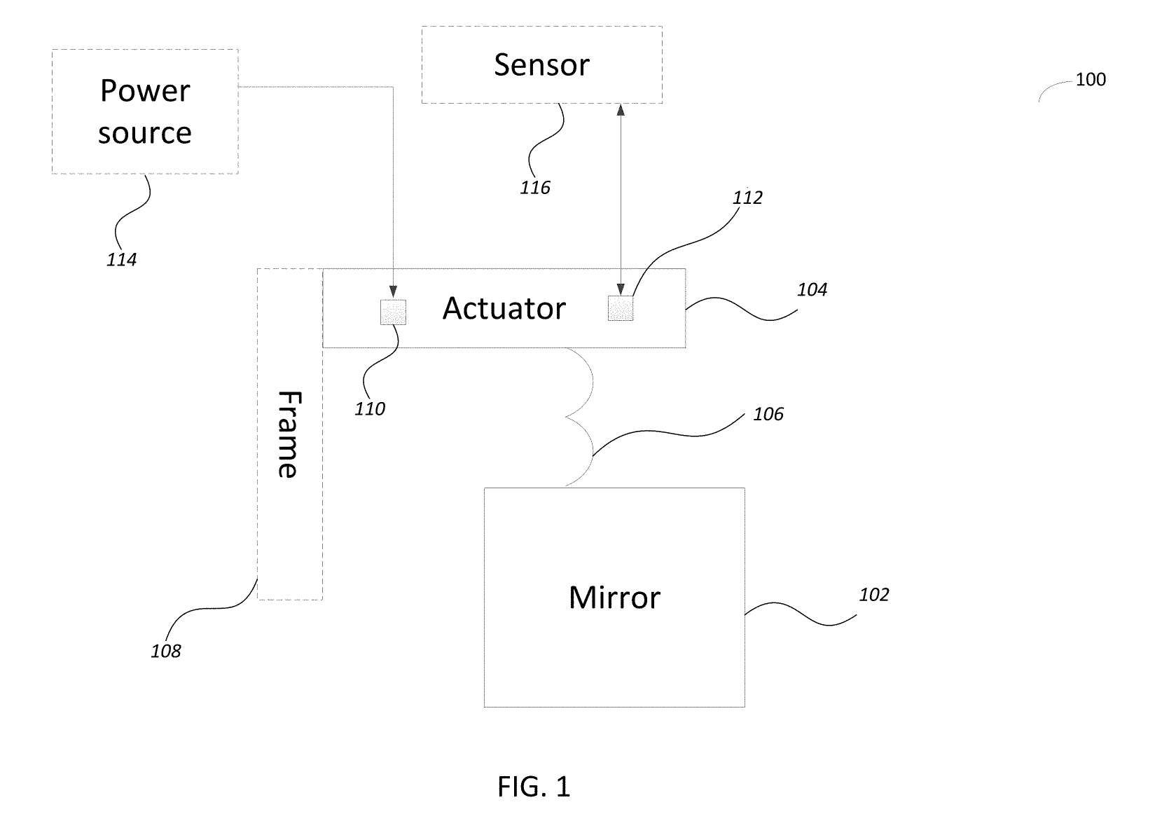

Turning to FIG. 1, shown is a steering device 100 which may be associated with or part of a scanning device. According to some embodiments, steering device 100 may include one or more reflective surfaces such as mirror 102, or a mirror base structure that can be attached to an external mirror assembly. Mirror 102 may be any reflective surface, for example, made from polished gold, aluminum, silicon, silver, or otherwise. Each of which reflective surfaces may be associated to an electrically controllable electromechanical actuator/cantilever/bender such as actuator 104. Actuator 104 may be a stepper motor, direct current motor, galvanometric actuator, electrostatic, magnetic or piezo elements or thermal based actuator or otherwise. Optionally, actuator 104 may include a piezo-electric layer and a semiconductor layer and optionally, a support or base layer. Actuator 104 may be connected to a support frame 108 and may further cause movement or power to be relayed to a flexible interconnect element or connector, such as spring 106. Spring 106 may be utilized to adjoin actuator 104 to mirror 102. Actuator 104 may include two or more electrical contacts such as contacts 110 and 112.

According to some embodiments, steering device 100 may include a single dual-axis mirror or dual single-axis mirrors or otherwise. According to some embodiments, actuator 104 may be a partially conductive element or may include embedded conductive circuitry. According to preferred embodiments, actuator 104 may include a semi conductive layer which may be made of a semi-conductive material which may be doped to have controllable conductive characteristics as can be achieved with silicon and similar materials. Accordingly, actuator 104 may be designed to be conductive in some sections and isolated (or function as isolation) in others. Conductivity may be achieved by doping a silicon based actuator, for example. Optionally, instead of doping actuator 104, actuator 104 may include a conductive element which may be adhered or otherwise mechanically or chemically connected to a non-conducting (or isolated or function as isolation) base layer of the actuator.

According to some embodiments, one of the contacts, such as contact 110 may be coupled to an electrical source 114 and may be utilized to provide electrical current, voltage and/or power to actuator 104. Contact 112 may be connected to a sensor 116 and may be used as an electrical sensing contact and used to measure one or more parameters of a sensing circuit. A parameter of a sensing circuit may include: current, voltage, current frequency, voltage frequency, capacitance, resistivity/resistance and/or charge and more. Sensor 116 may be electrical elements or logic circuitry and more. Electrical source 114 and/or sensor 116 may be external or included in steering device 100 and/or an associated scanning device. Optionally, steering device 100 may include contacts/inputs to connect to an external power source 114 and/or an external sensor 116. Furthermore, it is understood that contact 110 and 112 are interchangeable so that contact 110 may be connected to a sensor 116 and contact 112 may be connected to a power source 114.

According to some embodiments, actuator 104 may cause mirror 102 to move in a first direction, optionally actuator 104 may be configured to cause mirror 102 to move in two directions (forward and backwards for example). Optionally one or more of actuators may be utilized so that mirror 102 may move in a first range of directions represented by θ and one or more additional actuator's may be utilized to cause mirror 102 to move in a second range of directions represented by φ. Optionally the first and second range/directions are orthogonal to each other.

According to some embodiments, mirror 102 may include a mirror base structure support and the reflective elements may be adhesed or otherwise mechanically or chemically connected to the mirror base structure support.

According to some embodiments, sensor 116 may detect a mechanical breakdown or failure or may sense a mechanical deflection to indicate an actual position of mirror 102.

According to some embodiments, steering device 100 may be associated with a controller and a scanning device. The associated controller may utilize a detector feedback to determine if steering device 100 has a mechanical breakdown or failure and/or to compare an actual position of steering device 100 with an expected position. Optionally, scanning device may correct steering device 100 positioning based on the feedback or relay to a host device that a mechanical breakdown has occurred.

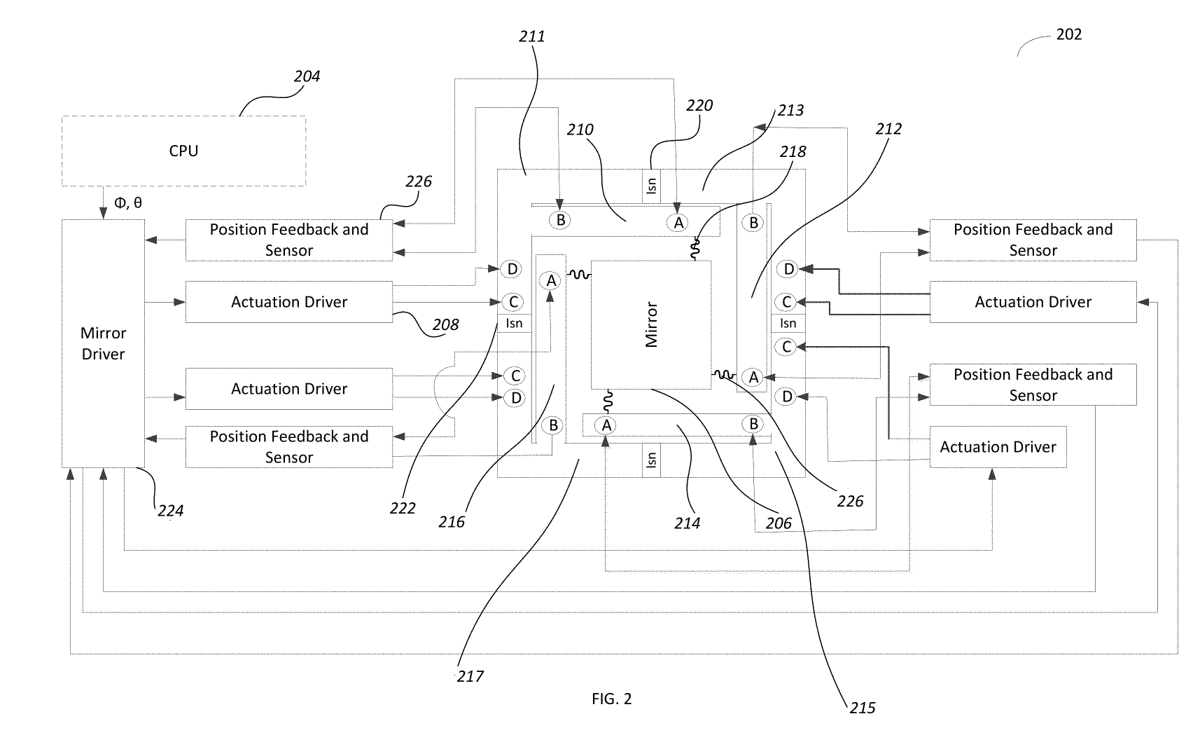

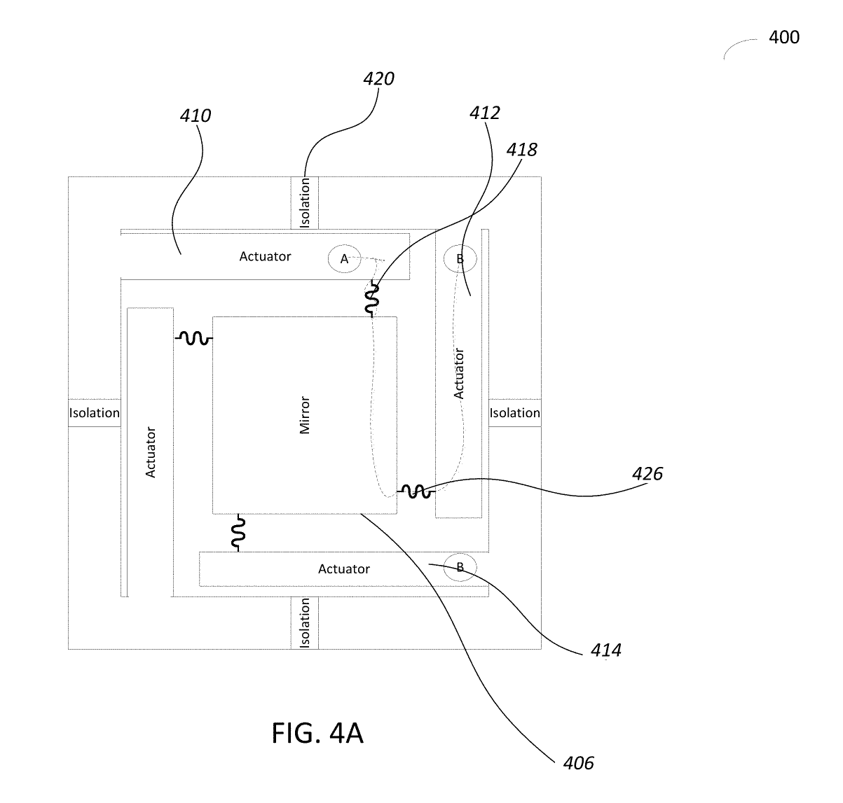

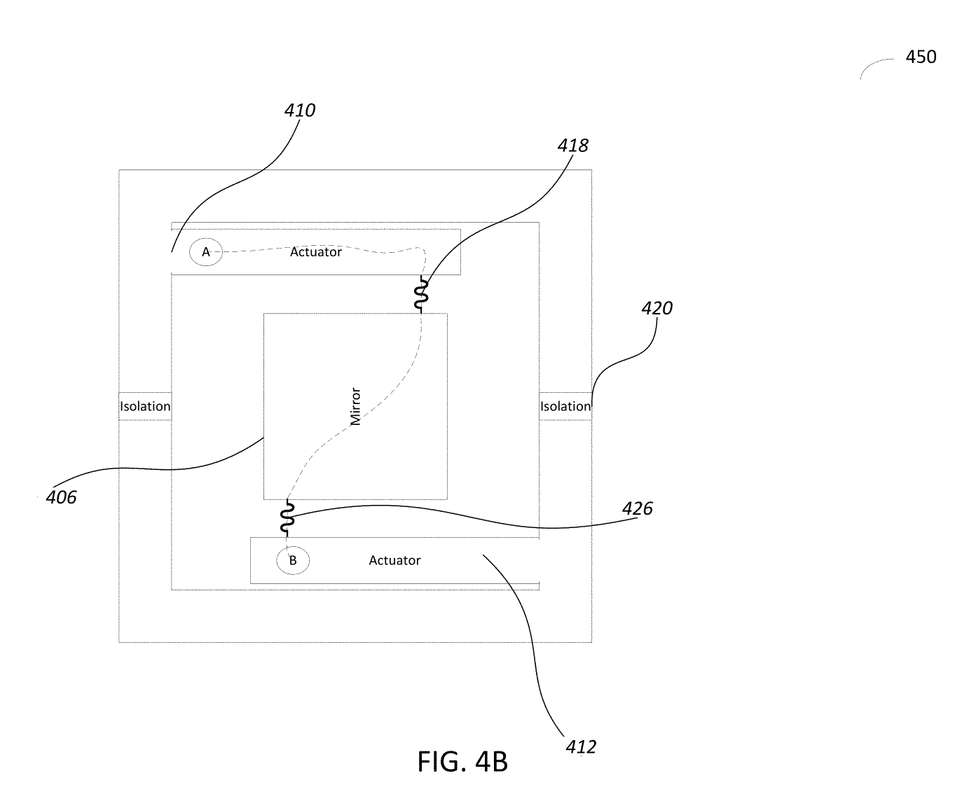

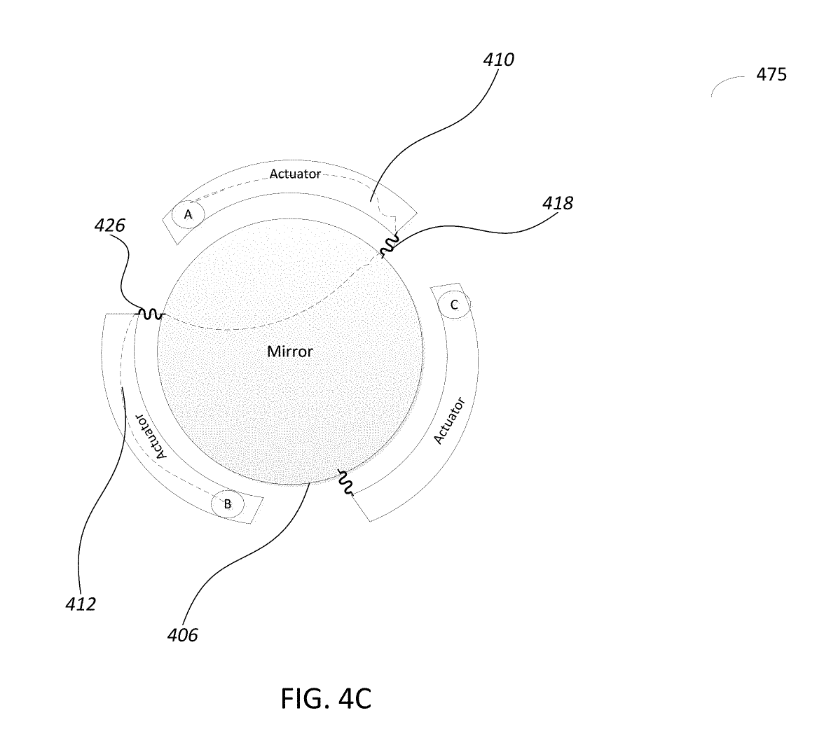

Turning to FIG. 2, shown is an example embodiment of steering device 202 and a central processing unit (CPU) such as controller 204 which may be local and included within scanning device 202 or a general controller of scanning device 202. Shown is an example mirror configuration including mirror 206 which can be moved in two or more axis (θ, φ). Understood from this figure in combination with FIGS. 4B&4C is also a single axis embodiment or a round embodiment. Mirror 206 may be associated with an electrically controllable electromechanical driver such as actuation driver 208. Actuation driver 208 may cause movement or power to be relayed to an actuator/cantilever/bender such as actuator 210. Actuator 210 may be part of a support frame such as frame 211 or they may be interconnected. Additional actuators such as actuator s 212, 214 and 216 may each be controller/driven by additional actuation drivers as shown, and may each have a support frame 213, 215 and 217 (appropriately). It is understood that frames 211, 213, 215 and/or 217 may comprise a single frame supporting all of the actuators or may be a plurality of interconnected frames. Furthermore the frames may be electrically separated by isolation (isn) elements or sections (as shown). Optionally, a flexible interconnect element or connector, such as spring 218, may be utilized to adjoin actuator 210 to mirror 206, to relay power or movement from actuation driver 208 to mirror 206. Actuator 210 may include two or more electrical contacts such as contacts 210A, 210B, 210C and 210D. Optionally, one or more contacts 210A, 210B, 210C and/or 210D may be situated on frame 211 or actuator 210 provided that frame 211 and actuator 210 are electronically connected. According to some embodiments, actuator 210 may be a semi-conductor which may be doped so that actuator 210 is generally conductive between contacts 210A-210D and isolative in isolation 220 and 222 to electronically isolate actuator 210 from actuators 212 and 216 (respectively). Optionally, instead of doping the actuator, actuator 210 may include a conductive element which may be adhesed or otherwise mechanically or chemically connected to actuator 210, in which case isolation elements may be inherent in the areas of actuator 210 that do not have a conductive element adhesed to them. Actuator 210 may include a piezo electric layer so that current flowing through actuator 210 may cause a reaction in the piezo electric section which may cause actuator 210 to controllably bend.

According to some embodiments, CPU 204 may output/relay to mirror driver 224 a desired angular position described by θ, φ parameters. Mirror driver 224 may be configured to control movement of mirror 206 and may cause actuation driver 208 to push a certain voltage amplitude to contacts 2100 and 210D in order to attempt to achieve specific requested values for θ, φ deflection values of mirror 206 based on bending of actuators 210, 212, 214 and 216 (appropriate operation of actuation drivers shown for the additional actuators is understood and discussed below).

According to some embodiments, position feedback control circuitry may be configured to supply an electrical source (such as voltage or current) to a contact such as contact 210A (or 210B) and the other contact such as 210B (or 210A, appropriately) may be connected to a sensor within position feedback 226, which may be utilized to measure one or more electrical parameters of actuator 210 to determine a bending of actuator 210 and appropriately an actual deflection of mirror 206.

According to some embodiments, as shown, additional positional feedback similar to position feedback 226 and an additional actuation driver similar to actuation driver 208 may be replicated for each of actuators 212-216 and mirror driver 224 and CPU 204 may control those elements as well so that a mirror deflection is controlled for all directions. The actuation drivers including actuation driver 208 may push forward a signal that causes an electro-mechanical reaction in actuators 210-216 which each, in turn is sampled for feedback. The feedback on the actuators' (210-216) positions serves as a signal to mirror driver 224 enabling it to converge efficiently towards the desired position ƒ, φ set by the CPU 204, correcting a requested value based on a detected actual deflection.

According to some embodiment, a scanning device or LiDAR may utilize piezoelectric actuator micro electro mechanical (MEMS) mirror devices for deflecting a laser beam scanning a field of view (FOV). Mirror 206 deflection is a result of voltage potential/current applied to the piezoelectric element that is built up on actuator 210. Mirror 206 deflection is translated into an angular scanning pattern that may not behave in a linear fashion, for a certain voltage level actuator 210 does not translate to a constant displacement value. A scanning LiDAR system where the FOV dimensions are deterministic and repeatable across different devices is optimally realized using a closed loop method that provides an angular deflection feedback from position feedback and sensor 226 to mirror driver 224 and/or CPU 204.

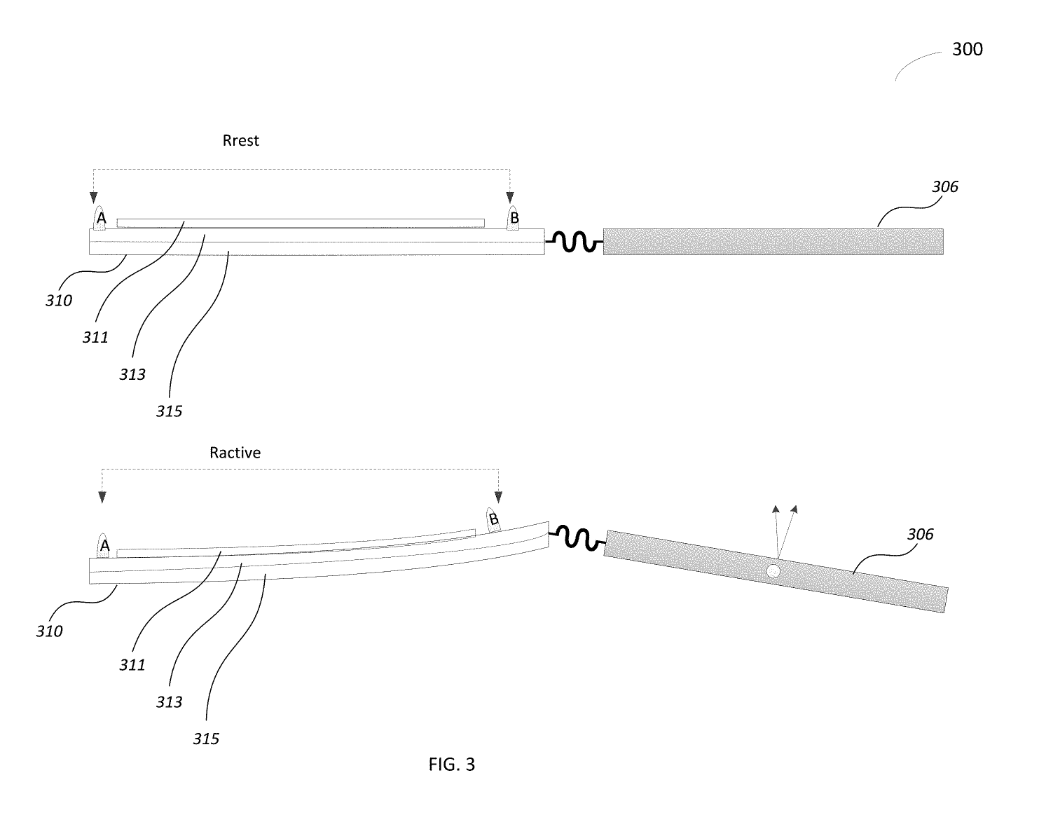

Turning to FIG. 3, shown is an example actuator-mirror depiction 300 in accordance with some embodiments. It is understood that mirror 306 may be an example embodiment of mirror 206 of FIG. 2 and that actuator 310 may be an example embodiment of actuator 210 also of FIG. 2. Actuator 310 is made of silicon and includes a PZT piezo electric layer 311, a semi conductive layer 313 and a base layer 315. Contacts 310A and 310B are substantially similar to contact 210A and 210B of FIG. 2. It is depicted that the resistivity of actuator 310 may be measured in an active stage (Ractive) when the mirror is deflected at a certain angular position and compared to the resistivity at a resting state (Rrest). A feedback including Ractive may provide information to measure/determine the actual mirror deflection angle compared to an expected angle and accordingly, mirror 306 deflection may be corrected. The physical property of the silicon (or semiconductor) based actuator 310 is based on an observable modulation of its electrical conductivity according to mechanical stresses that actuator 310 experiences. When actuator 310 is at rest the electrical conductivity exhibited at the two contacts 310A and 310B would be Rrest. The PZT material of layer 311, if activated (by applying electrical voltage/current), would exert force on actuator 310 and cause it to bend. Bending actuator 310 experiences a mechanical force that would modify the electrical conductivity Ractive exhibited at the two contacts 310A and 310B. The difference between Rrest and Ractive is correlated by a mirror drive (such as mirror driver 224 of FIG. 2) into an angular deflection value that serves to close the loop. This method is used for dynamic tracking of the actual mirror position and may optimize response, amplitude, and deflection efficiency, frequency for both linear mode and resonant mode MEMS mirror schemes. Controlling the supply current/voltage may enable an expected Ractive to be achieved and appropriately an intended deflection.

Returning to FIG. 2, position feedback and sensor 226 may also be utilized as a reliability feedback module. According to some embodiments, a plurality of elements may include semiconductors or conducting elements, or a layer and accordingly, actuators 201-216 could at least partially include a semi conducting element, springs 218, 226, 228 and 230 may each include a semiconductor and so may mirror 206. Electrical Power (current and/or voltage) may be supplied at a first actuator contact via position feedback 226 and position feedback 226 may sense an appropriate signal at actuator 212, 214 and/or 216 via contacts 212 A or 212 B, 214A or 214B and/or 216A or 216B.

Turning to FIG. 4A depicting a dual axis mems mirror (400), FIG. 4B depicting a single axis mems mirror (450) and FIG. 4C depicting a round mems mirror (475). It is understood that current may be able to flow from contact 410A to contact 412B (through actuator 410 then through spring 418, mirror 406, spring 426 and to actuator 412). Isolation gaps in the semiconducting frame such as isolation 420 may cause actuator 410 and 412 to be two separate islands connected electrically through the springs and mirror or mirror base structure as described. The current flow or associated electrical parameter (voltage, current frequency etc.) may be monitored by an associated position feedback. In case of a mechanical failure where spring 418, spring 426, actuator 410, actuator 412 and/or mirror or mirror base structure 406 is damaged the current flow (or associated electrical parameter) through the structure would alter and change from its functional/calibrated values. At an extreme situation (for example if a spring is broken), the current would stop completely as there's a circuit break in the electrical chain by means of a faulty element. It is understood that a plurality of contacts may be utilized to check relevant elements of the modules 400 and 450 such as current flowing in additional contacts, for example in FIG. 4A current through such as from actuator 410 to actuator 414 via contact 414B. As well known in electronics, a plurality of elements defining circuits may be controlled so that the circuits can be checked simultaneously or serially. Furthermore, monitoring for a breakdown may be carried out periodically or continuously.

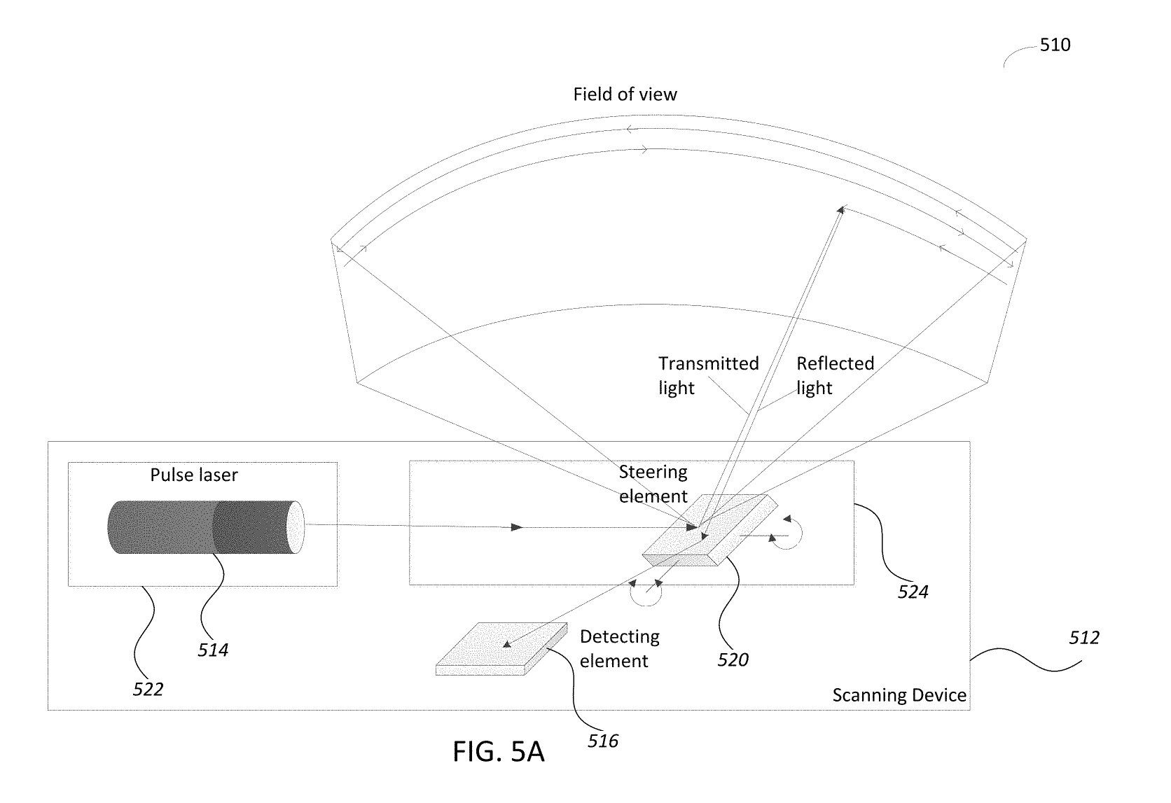

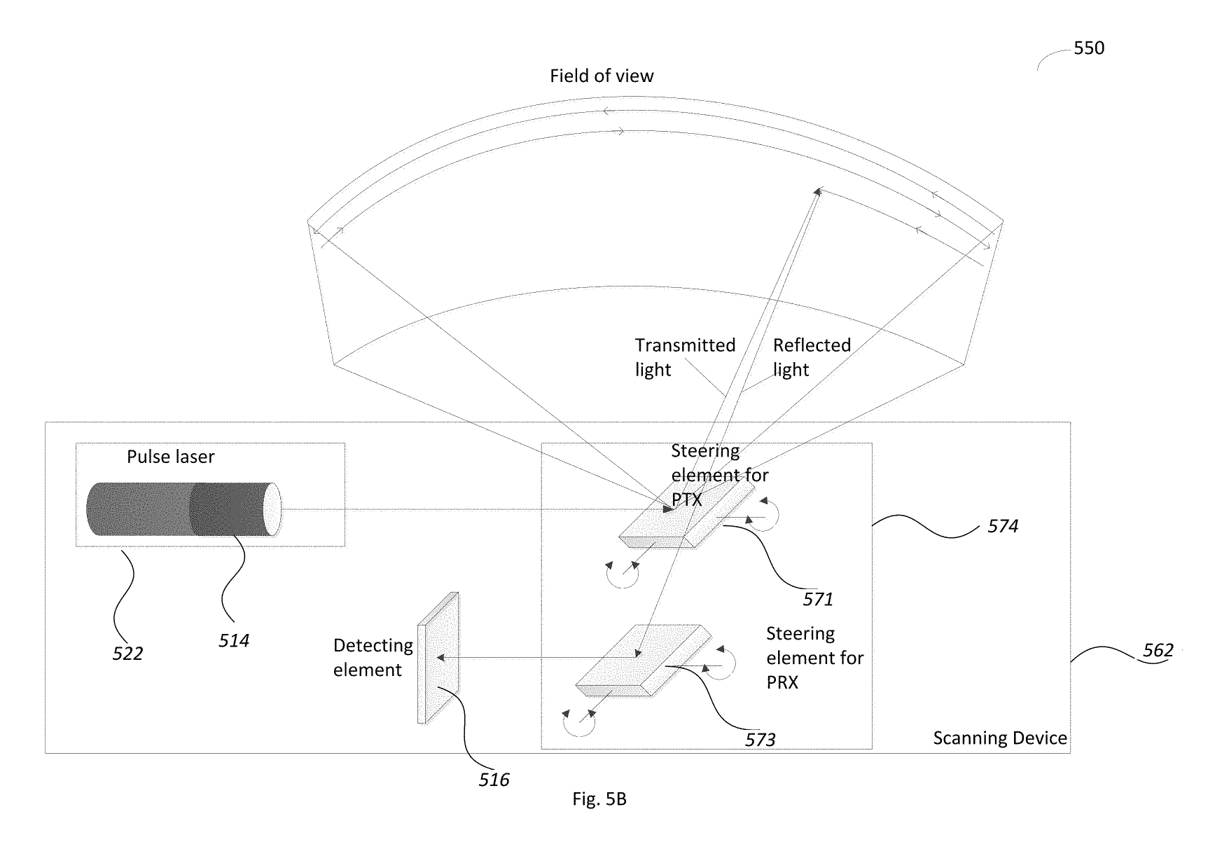

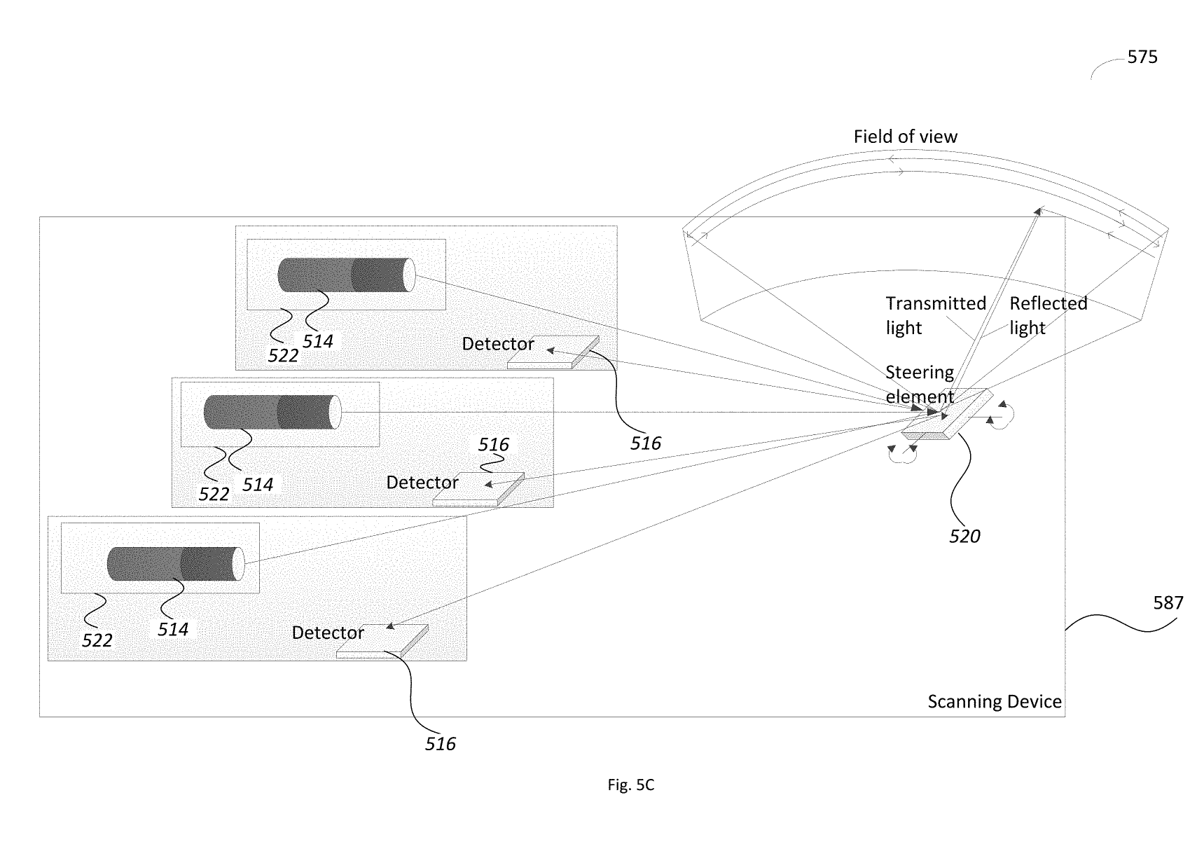

Turning to FIG. 5A, depicted is an example monostatic scanning device schematic 510. According to some embodiments, there may be provided a scene scanning device such as scanning device 512 which may be adapted to inspect regions or segments of a scene (shown here is a specific field of view (FOV) being scanned) using photonic pulses (transmitted light) whose characteristics may be dynamically selected as a function of: (a) optical characteristics of the scene segment being inspected; (b) optical characteristics of scene segments other than the one being inspected; (c) scene elements present or within proximity of the scene segment being inspected; (d) scene elements present or within proximity of scene segments other than the one being inspected; (e) an operational mode of the scanning device; and/or (f) a situational feature/characteristic of a host platform with which the scanning device is operating. The scene scanning device may be adapted to inspect regions or segments of a scene using a set of one or more photonic transmitters 522 (including a light source such as pulse laser 514), receptors including sensors (such as detecting element 516) and/or steering assemblies 524 (which may include steering element 520); whose configuration and/or arrangement may be dynamically selected as a function of: (a) optical characteristics of the scene segment being inspected; (b) optical characteristics of scene segments other than the one being inspected; (c) scene elements present or within proximity of the scene segment being inspected; (d) scene elements present or within proximity of scene segments other than the one being inspected; (e) an operational mode of the scanning device; and/or (f) a situational characteristic of a host platform with which the scanning device is operating. It is understood that steering assembly 524 may be substantially similar to steering device 202 of FIG. 2. Active scanning device 512 may include: (a) a photonic emitter assembly 522 which produces pulses of inspection photons; (b) a photonic steering assembly 524 that directs the pulses of inspection photons to/from the inspected scene segment; (c) a photonic detector assembly 516 to detect inspection photons reflected back from an object within an inspected scene segment; and (d) a controller to regulate operation of the photonic emitter assembly, the photonic steering assembly and the operation of the photonic detection assembly in a coordinated manner and in accordance with scene segment inspection characteristics of the present invention at least partially received from internal feedback of the scanning device so that the scanning device is a closed loop dynamic scanning device. A closed loop scanning device is characterized by having feedback from at least one of the elements and updating one or more parameter based on the received feedback. A closed loop system may receive feedback and update the system's own operation at least partially based on that feedback. A dynamic system or element is one that may be updated during operation.

According to some embodiments, inspection of a scene segment may include illumination of the scene segment or region with a pulse of photons (transmitted light), which pulse may have known parameters such as pulse duration, pulse angular dispersion, photon wavelength, instantaneous power, photon density at different distances from the emitter average power, pulse power intensity, pulse width, pulse repetition rate, pulse sequence, pulse duty cycle, wavelength, phase, polarity and more. Inspection may also include detecting and characterizing various aspects of reflected inspection photons, which reflected inspection photons are inspection pulse photons (reflected light) reflected back towards the scanning device (or laser reflection) from an illuminated element present within the inspected scene segment (i.e. scene segment element). Characteristics of reflected inspection photons may include photon time of flight (time from emission till detection), instantaneous power (or power signature) at and during return pulse detection, average power across entire return pulse and photon distribution/signal over return pulse period the reflected inspection photons are a function of the inspection photons and the scene elements they are reflected from and so the received reflected signal is analyzed accordingly. In other words, by comparing characteristics of a photonic inspection pulse with characteristics of a corresponding reflected and detected photonic pulse, a distance and possibly a physical characteristic such as reflected intensity of one or more scene elements present in the inspected scene segment may be estimated. By repeating this process across multiple adjacent scene segments, optionally in some pattern such as raster, Lissajous or other patterns, an entire scene may be scanned in order to produce a map of the scene.

The definition according to embodiments of the present invention may vary from embodiment to embodiment, depending on the specific intended application of the invention. For Lidar applications, optionally used with a motor vehicle platform/host and or drone platform/host, the term scene may be defined as the physical space, up to a certain distance, in-front, behind, below and/or on the sides of the vehicle and/or generally in the vicinity of the vehicle or drone in all directions. The term scene may also include the space behind the vehicle or drone in certain embodiments. A scene segment or scene region according to embodiments may be defined by a set of angles in a polar coordinate system, for example, corresponding to a pulse or beam of light in a given direction. The light beam/pulse having a center radial vector in the given direction may also be characterized by angular divergence values, polar coordinate ranges of the light beam/pulse and more.

Turning to FIG. 5B, depicted is an example bi-static scanning device schematic 550. It is understood that scanning device 562 is substantially similar to scanning device 512. However, scanning device 512 is a monostatic scanning device while scanning device 562 is a bi static scanning device. Accordingly, steering element 574 is comprised of two steering elements: steering element for PTX 571 and steering element for PRX 573. The rest of the discussion relating to scanning device 512 of FIG. 5A is applicable to scanning device 562 of FIG. 5B.

Turning to FIG. 5C, depicted is an example scanning device schematic 575 with a plurality of photonic transmitters 522 and a plurality of detectors 516. All of the transmitters 522 and detectors 516 may have a joint steering element 520. It is understood that scanning device 587 is substantially similar to scanning device 512. However, scanning device 587 is a monostatic scanning device with a plurality of transmitting and receiving elements. The rest of the discussion relating to scanning device 512 of FIG. 5A is applicable to scanning device 587 FIG. 5C.

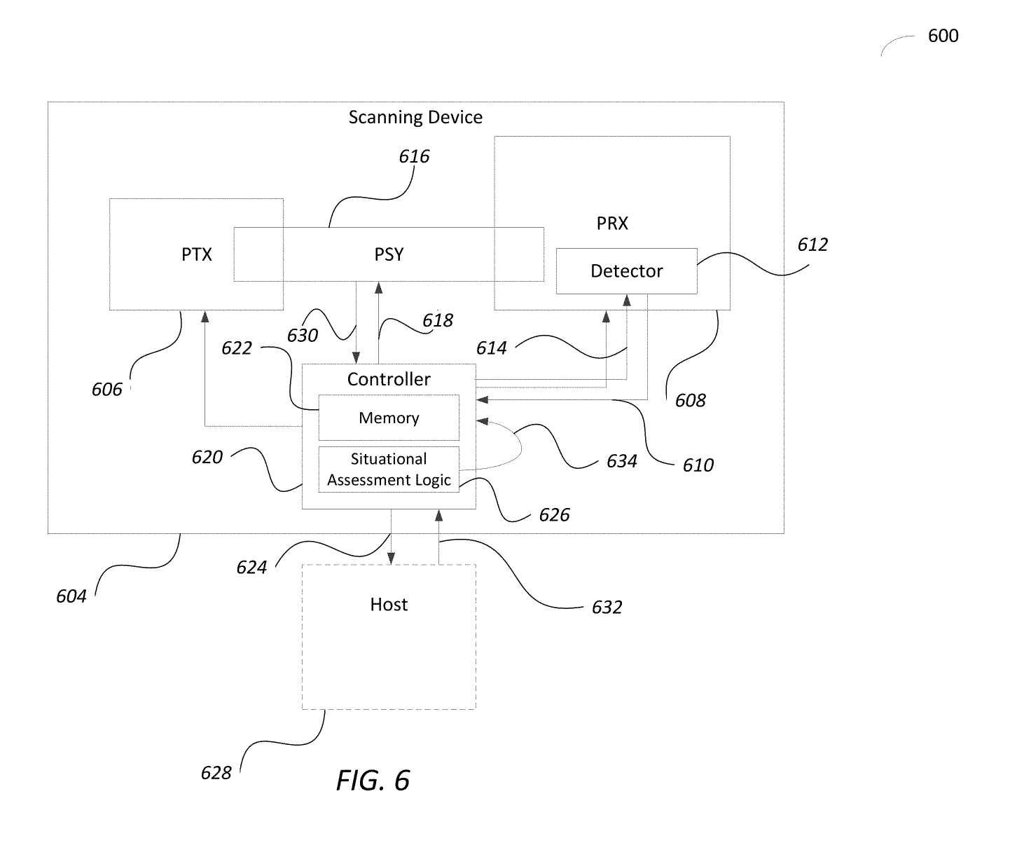

Turning to FIG. 6, depicted is an example scanning system 600 in accordance with some embodiments. Scanning system 600 may be configured to operate in conjunction with a host device 628 which may be a part of system 600 or may be associated with system 600. Scanning system 600 may include a scene scanning device such as scanning device 604 adapted to inspect regions or segments of a scene using photonic pulses whose characteristics may be dynamically selected. Scanning device 604 may include a photonic emitter assembly (PTX) such as PTX 606 to produce pulses of inspection photons. PTX 606 may include a laser or alternative light source. The light source may be a laser such as a solid state laser, a high power laser or otherwise or an alternative light source such as, a LED based light source or otherwise. Scanning device 604 may be an example embodiment for scanning device 512 of FIG. 5A and/or scanning device 562 of FIG. 5B and/or scanning device 587 of FIG. 5C and the discussion of those scanning devices is applicable to scanning device 604.

According to some embodiments, the photon pulses may be characterized by one or more controllable pulse parameters such as: pulse duration, pulse angular dispersion, photon wavelength, instantaneous power, photon density at different distances from the emitter average power, pulse power intensity, pulse width, pulse repetition rate, pulse sequence, pulse duty cycle, wavelength, phase, polarity and more. The inspection photons may be controlled so that they vary in pulse duration, pulse angular dispersion, photon wavelength, instantaneous power, photon density at different distances from the emitter average power, pulse power intensity, pulse width, pulse repetition rate, pulse sequence, pulse duty cycle, wavelength, phase, polarity and more. The photon pulses may vary between each other and the parameters may change during the same signal. The inspection photon pulses may be pseudo random, chirp sequence and/or may be periodical or fixed and/or a combination of these. The inspection photon pulses may be characterized as: sinusoidal, chirp sequences, step functions, pseudo random signals, or linear signals or otherwise.

According to some embodiments, scanning device 604 may include a photonic reception and detection assembly (PRX) such as PRX 608 to receive reflected photons reflected back from an object or scene element and produce detected scene signal 610. PRX 608 may include a detector such as detector 612. Detector 612 may be configured to detect the reflected photons reflected back from an object or scene element and produce detected scene signal 610.

According to some embodiments, detected scene signal 610 may include information such as: time of flight which is indicative of the difference in time between the time a photon was emitted and detected after reflection from an object, reflected intensity, polarization values and more.

According to some embodiments, scanning device 604 may be a bi static scanning device where PTX 606 and PRX 608 have separate optical paths or scanning device 604 may be a monostatic scanning system where PTX 606 and PRX 608 have a joint optical path.

According to some embodiments, scanning device 604 may include a photonic steering assembly (PSY), such as PSY 616, to direct pulses of inspection photons from PTX 606 in a direction of an inspected scene and to steer reflection photons from the scene back to PRX 608. PTX 616 may also be in charge of positioning the singular scanned pixel window onto/in the direction of detector 612.

According to some embodiments, PSY 216 may be a joint PSY, and accordingly, may be joint between PTX 606 and PRX 608 which may be a preferred embodiment for a monostatic scanning system

According to some embodiments, PSY 616 may include a plurality of steering assemblies or may have several parts one associated with PTX 616 and another associated with PRX 608.

According to some embodiments PSY 616 may be a dynamic steering assembly and may be controllable by steering parameters control 618. Example steering parameters may include: scanning method that defines the acquisition pattern and sample size of the scene, power modulation that defines the range accuracy of the acquired scene; correction of axis impairments based on collected feedback and reliability confirmation and controlling deflection as described above.

According to some embodiments PSY 616 may include: (a) a Single Dual-Axis MEMS mirror; (b) a dual single axis MEMS mirror; (c) a mirror array where multiple mirrors are synchronized in unison and acting as a single large mirror; (d) a mirror splitted array with separate transmission and reception and/or (e) a combination of these and more.

According to some embodiments; if PSY 616 includes a MEMS splitted array the beam splitter may be integrated with the laser beam steering. According to further embodiments, part of the array may be used for the transmission path and the second part of the array may be used for the reception path. The transmission mirrors may be synchronized and the reception mirrors may be synchronized separately from the transmission mirrors. The transmission mirrors and the reception mirrors sub arrays maintain an angular shift between themselves in order to steer the beam into separate ports, essentially integrating a circulator module.

According to some embodiments, As described with regard to FIG. 1-FIG. 4A&B, PSY 616 may include one or more PSY state sensors to produce a signal indicating an operational state of PSY 616 for example power information or temperature information, reflector state, reflector actual axis positioning, reflector mechanical state and more, as discussed in the embodiments above.

According to some embodiments, PSY 616 may include one or more reflective surfaces, each of which reflective surface may be associated to an electrically controllable electromechanically actuator. The reflective surface(s) may be made from polished gold, aluminum, silicon, silver, or otherwise. The electrometrical actuator(s) may be selected from actuators such as stepper motors, direct current motors, galvanometric actuators, electrostatic, magnetic or piezo elements or thermal based actuators. PSY 616 may include or be otherwise associated with one or more microelectromechanical systems (MEMS) mirror assemblies. A photonic steering assembly according to refractive embodiments may include one or more reflective materials whose index of refraction may be electrically modulated, either by inducing an electric field around the material or by applying electromechanical vibrations to the material.

According to some embodiments, scanning device 604 may include a controller, such as controller 620. Controller 604 may receive scene signal 610 from detector 612 and may control PTX 606, PSY 618 PRX 608 including detector 612 based on information stored in the controller memory 622 as well as received scene signal 610 including accumulated information from a plurality of scene signals 610 received over time.

According to some embodiments, controller 620 may process scene signal 610 optionally, with additional information and signals and produce a vision output such as vision signal 624 which may be relayed/transmitted/to an associated host device. Controller 620 may receive detected scene signal 610 from detector 612, optionally scene signal 610 may include time of flight values and intensity values of the received photons. Controller 620 may build up a point cloud or 3D or 2D representation for the FOV by utilizing digital signal processing, image processing and computer vision techniques.

According to some embodiments, controller 620 may include situational assessment logic or circuitry such as situational assessment logic (SAL) 626. SAL 626 may receive detected scene signal 610 from detector 612 as well as information from additional blocks/elements either internal or external to scanning device 104.

According to some embodiments, scene signal 210 can be assessed and calculated according with or without additional feedback signals such as a PSY feedback PTX feedback, PRX feedback and host feedback and information stored in memory 622 to a weighted means of local and global cost functions that determine a work plan such as work plan signal 634 for scanning device 604 (such as: which pixels in the FOV are scanned, at which laser parameters budget, at which detector parameters budget). Accordingly, controller 620 may be a closed loop dynamic controller that receives system feedback and updates the system's operation based on that feedback.

According to some embodiments, SAL 626 may receive one or more feedback signals from PSY 616 via PSY feedback 630. PSY feedback 630 may include instantaneous position of PSY 616 where PSY 616 may include one or more reflecting elements and each reflecting element may contain one or more axis of motion, it is understood that the instantaneous position may be defined or measured in one or more dimensions. Typically, PSY's have an expected position however PSY 616 may produce an internal signal measuring the instantaneous position (meaning, the actual position) then providing such feedback may be utilized by situational assessment logic 626 for calculating drifts and offsets parameters in the PRX and/or for correcting steering parameters control 218 of PSY 616 to correct an offset. Furthermore, PSY feedback 630 may indicate a mechanical failure which may be relayed to host 628 which may either compensate for the mechanical failure or control host 628 to avoid an accident due to the mechanical failure.

According to some embodiments, PSY feedback 630 may include instantaneous scanning speed of PSY 616. PSY 616 may produce an internal signal measuring the instantaneous speed (meaning, the actual speed and not the estimated or anticipated speed) then providing such feedback may be utilized by situational assessment logic 626 for calculating drifts and offsets parameters in the PRX and/or for correcting steering parameters control 618 of PSY 616 to correct an offset.

According to some embodiments, PSY feedback 630 may include instantaneous scanning frequency of PSY 616. PSY 616 may produce an internal signal measuring the instantaneous frequency (meaning, the actual frequency and not the estimated or anticipated frequency) then providing such feedback may be utilized by situational assessment logic 626 for calculating drifts and offsets parameters in the PRX and/or for correcting steering parameters control 618 of PSY 616 to correct an offset. The instantaneous frequency may be relative to one or more axis.

According to some embodiments, PSY feedback 630 may include mechanical overshoot of PSY 616, which represents a mechanical de-calibration error from the expected position of the PSY in one or more axis. PSY 616 may produce an internal signal measuring the mechanical overshoot then providing such feedback may be utilized by situational assessment logic 626 for calculating drifts and offsets parameters in the PRX and/or for correcting steering parameters control 618 of PSY 616 to correct an offset. PSY feedback may also be utilized in order to correct steering parameters in case of vibrations induced by the LiDAR system or by external factors such as vehicle engine vibrations or road induces shocks.

According to some embodiments, PSY feedback 630 may be utilized to correct steering parameters 618 to correct the scanning trajectory and linearize it. The raw scanning pattern may typically be non-linear to begin with and contains artifacts resulting from fabrication variations and the physics of the MEMS mirror or reflective elements. Mechanical impairments may be static, for example a variation in the curvature of the mirror, and dynamic, for example mirror warp/twist at the scanning edge of motion correction of the steering parameters to compensate for these non-linearizing elements may be utilized to linearize the PSY scanning trajectory.

According to some embodiments, SAL 626 may receive one or more signals from memory 622. Information received from the memory may include laser power budget (defined by eye safety limitations, thermal limitations reliability limitation or otherwise); electrical operational parameters such as current and peak voltages; calibration data such as expected PSY scanning speed, expected PSY scanning frequency, expected PSY scanning position and more.

According to some embodiments, steering parameters of PSY 616, detector parameters of detector 612 and/or pulse parameters of PTX 606 may be updated based on the calculated/determined work plan 634. Work plan 634 may be tracked and determined at specific time intervals and with increasing level of accuracy and refinement of feedback signals (such as 630 and 632).

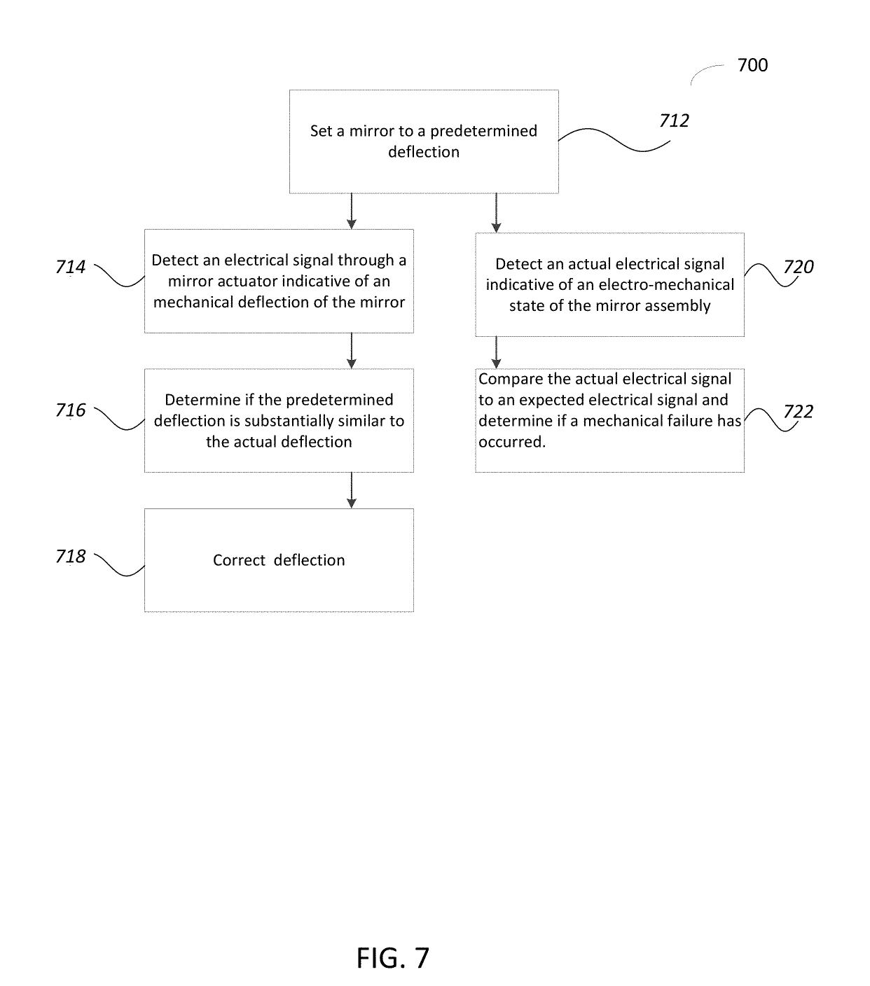

Turning to FIG. 7 shown is a flow chart 700 of a method for scanning in accordance with some embodiments. A mirror may be set to a predetermined controllable deflection (712). An electrical signal indicative if an actual mechanical deflection may be detected (714) and used to determine if the predetermined deflection is substantially similar to the actual deflection (within an allowed range surrounding the predetermined deflection) (716) and if the actual deflection is substantially different than predetermined deflection the mirror's deflection may be corrected (718).

According to some embodiments, an electrical signal indicative of an electro-mechanical state of the mirror assembly may be detected (720) and compared to an expected electrical signal (722) to determine if a mechanical failure has occurred.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A light steering device comprising:
a mirror connected to one or more electro mechanical actuators through a flexible interconnect element;
one or more actuators interconnected to a frame; and
a controllable electric source to, during operation of said device, provide sensing signal at a source voltage to an electric source contact on at least one of said one or more actuators.

2. The light steering device according to claim 1, and further comprising an electrical parameter sensing circuit connected to an electric sensing contact on at least one of said one or more actuators, and to during operation of said device measure parameters of the sensing circuit.

3. The light steering device according to claim 2, wherein said electric source and said electrical parameter sensing circuit are connected to the same actuator and facilitate sensing of a mechanical deflection of the actuator to which said electric source and said current sensing circuit are connected.

4. The light steering device of claim 3, further comprising a sensor to relay a signal indicating an actual deflection determined based on said mechanical deflection.

5. The light steering device of claim 4, wherein said device further comprises a controller to control said controllable electric source and said electrical parameter sensing circuit.

6. The light steering device of claim 5, wherein said controller is further configured to control deflection of said actuator.

7. The light steering device of claim 6, wherein said controller is configured to correct a steering signal based on said sensed mechanical deflection.

8. The light steering device according to claim 2, wherein said electric source and said electrical parameter sensing circuit are each connected to a contact on two separate actuators and facilitate sensing of a mechanical failure of one or more elements supported by the two separate actuators.

9. The light steering device according to claim 8, wherein said sensing of a mechanical failure is determined based on an amplitude of a sensed current.

10. The light steering device according to claim 9, wherein said sensing of a mechanical failure is determined based on a difference between an expected current and a sensed current.

11. A scanning device comprising:
a photonic emitter assembly (PTX) to produce pulses of inspection photons wherein said pulses are characterized by at least one pulse parameter;
a photonic reception and detection assembly (PRX) to receive reflected photons reflected back from an object, said PRX including a detector to detect the reflected photons and produce a detected scene signal;
a photonic steering assembly (PSY) functionally associated with both said PTX and said PRX to direct said pulses of inspection photons in a direction of an inspected scene segment based on at least one PSY parameter and to produce a sensing signal; and
a closed loop controller to: (a) control said PSY, (b) receive said sensing signal and (c) update said at least one PSY parameter at least partially based on said detected scene signal.

12. The scanning device according to claim 11, wherein said sensing signal is indicative of an actual deflection of said PSY.

13. The scanning device according to claim 11, wherein said sensing signal is indicative of a mechanical failure.

14. A method of scanning utilizing a mirror assembly including a mirror and conductive actuator, the method comprising:
setting a mirror having a conductive actuator to a predetermined deflection;
detecting a current through said actuator indicative of an mechanical deflection of said mirror; and
determining if the predetermined direction is substantially similar to said actual deflection.

15. The method according to claim 14, further comprising correcting said actual deflection if said predetermined deflection and said actual deflection are substantially different.

16. The method according to claim 14, further comprising detecting an actual current through said actuator and said mirror indicative of a electro-mechanical state of said mirror assembly.

17. The method according to claim 16, further comprising comparing said actual current to an expected current and determining if a mechanical failure has occurred.
